(19) United States
(12) Patent Application Publication
(10) Pub. No.: US 2022/0054338 A1
(43) Pub. Date: Feb. 24, 2022

(54) APPARATUS AND METHOD OF MANAGING PRESSURE INJURIES

(71) Applicant: Cooper Shifrin, Lebanon, CT (US)

(72) Inventor: Cooper Shifrin, Lebanon, CT (US)

(21) Appl. No.: 17/405,830

(22) Filed: Aug. 18, 2021

Related U.S. Application Data
(60) Provisional application No. 63/068,705, filed on Aug. 21, 2020.

(51) Int. Cl. A61G 7/057; A61G 5/10

(52) U.S. Cl. CPC A61G 7/05776; A61G 2203/34; A61G 5/1091

(57) ABSTRACT

A process (and apparatus) of managing pressure injuries provides a two-dimensional array of expandable, compressible cells. Each cell has a contact surface with an associated contact pressure, and the array of cells includes a given cell with a given contact surface and at least one cell adjacent to the given cell (“adjacent cell”). A controller expands the array of cells. The process also monitors the contact pressure of a body on the contact surface and detects a given contact pressure exceeding or equal to a predetermined threshold contact pressure. The controller may produce a pressure reduction response when determining that the given contact pressure exceeds or equals the predetermined threshold contact pressure. This automatically causes the controller to modify the internal air pressure of the given cell and the internal air pressure of the adjacent cell.

### PRIORITY

This patent application claims priority from Provisional U.S. Patent Application No. 63/068,705, filed Aug. 21, 2020, entitled, “APPARATUS AND METHOD OF MANAGING PRESSURE INJURIES,” and naming Cooper Shifrin as inventor, the disclosure of which is incorporated herein, in its entirety, by reference.

### GOVERNMENT RIGHTS

None

### FIELD

Illustrative embodiments of the generally relate to managing pressure injuries and, more particularly, various embodiments of the invention relate to techniques for mitigating pressure injuries.

### BACKGROUND OF THE INVENTION

For people with disorders, diseases, or injuries that cause a lack of mobility, as well as their caretakers, the prevention, diagnosis, and treatment of pressure injuries is a tremendous task. A pressure injury can form when an area of the skin is exposed to high pressure (e.g., greater than 32 mmHg) for a relatively long time (e.g., more than two hours).

A pressure injury can also develop when any area of skin is exposed to significantly greater pressure for a shorter period. For example, after exposure to pressure 32 mmHg or greater for a given period, blood flow through dermal, and, in some cases, subcutaneous layers of the skin is restricted, leading to ischemia. After an extended period of ischemia, necrosis takes place, leading to ulceration—a pressure injury. Contributing factors include nutrition, moisture, sensory perception, blood pressure, friction, and shear. The depth and width of the injury are typically dependent on the severity and duration of the pressure that caused the onset of ulceration.

To avoid the development of pressure injuries, caretakers, and those at risk of developing pressure injuries (referred to as “patients”) are responsible for repositioning the patient regularly, such as every 2 hours. The frequency of repositioning can change depending on medical opinion and is usually determined after analysis of the level of risk (e.g., based on experience or various techniques, such as the Braden or Norton scales). Each scale takes into account multiple factors, including; sensory perception, moisture, activity, mobility, nutrition, friction, shear, mental state, and continence. Using this analysis tool, the frequency of repositioning is determined—the standard for those at moderate to high risk (14 or less on the Braden Scale and 17 or less on the Norton Scale) is every 2 hours. For caretakers and people at risk for pressure injury development, this is an enormous burden that typically cannot be met.

Pressure injuries can also be difficult to detect. For example, pressure injuries can form under the skin, making formation and severity difficult to determine. Furthermore, the diagnosis of a pressure injury often requires a caretaker to recognize a visible or physical signal of change in the properties of the skin. These typically include a difference in color, temperature, and hardness or softness of the skin. Identifying these changes soon after the onset of ulceration generally requires the continuous evaluation of the skin for those who are at risk.

After the pressure injury has been identified, removing pressure from the affected area can be a substantial challenge. Among other issues, those who are at the most significant risk for pressure injuries typically lack mobility. This makes being positioned in such a way that completely removes pressure from the affected area a difficult task for caretakers. Undesirably, it can sometimes be impossible to remove pressure from the affected area. Today, caretakers often simply use pillows to remove pressure from the affected area.

### SUMMARY OF VARIOUS EMBODIMENTS

In accordance with one embodiment of the invention, a process of managing pressure injuries provides a two-dimensional array of expandable, compressible cells. Each cell has a contact surface with an associated contact pressure, and the array of cells includes a given cell with a given contact surface and at least one cell adjacent to the given cell (“adjacent cell”). The process also provides a controller comprising hardware, software, or both hardware and software, expands the array of cells with a fluid so that each cell has a resultant internal air pressure. The process also receives a body (e.g., a person) on the expanded array of cells so that the body contacts the contact surface(s) of a set of the cells, monitors the contact pressure of the body on the contact surface of each of the set of cells, and detects, on the given contact surface of the given cell, a given contact pressure exceeding or equal to a predetermined threshold contact pressure.

The controller is configured to produce a pressure reduction response when detecting, via the monitor, that the given contact pressure exceeds or equals the predetermined threshold contact pressure. The pressure reduction response automatically causes the controller to modify the internal air pressure of the given cell and the internal air pressure of the adjacent cell in response to detecting the given contact pressure exceeding or equal to the threshold contact pressure. In addition, the pressure reduction response causes the controller to reduce the contact pressure of the given contact surface of the given cell.

The pressure reduction response may cause the controller to reduce the contact pressure of the given contact surface of the given cell to a non-zero contact pressure. Preferably, the pressure reduction response may cause the controller to reduce the contact pressure of the adjacent cell contact surface to a non-zero contact pressure. Functionally, the cells may be fluidly isolated from other of the cells via at least one valve. To detect contact pressure (on its contact surface), each cell has an associated pressure sensor.

After modifying the internal air pressures of the given and adjacent cells, the given cell has a first air pressure and the adjacent cell has a second air pressure. The first air pressure may be less than the second air pressure. In a similar manner, after modifying the internal air pressures of the given and adjacent cells, the given cell has a first height and the adjacent cell has a second, greater height than that of the given cell. Among other time frames, the pressure reduction response automatically can cause the controller to modify the internal air pressure of the given cell and the internal air pressure of the adjacent cell in between 1 second and 5 minutes.

Each cell may, in some cases, continuously monitor the contact pressure of the body on the contact surface of each cell. Alternatively, each cell comprises may, in some cases, periodically monitor the contact pressure of the body on the contact surface of each cell.

In accordance with another embodiment, a pressure injury management surface apparatus has a two-dimensional array of expandable, compressible cells. As with some other embodiments, each cell has a contact surface with an associated contact pressure, and the array of cells includes a given cell with a given contact surface, the array of cells also having at least one cell adjacent to the given cell (“adjacent cell”). The apparatus also has a set of contact pressure sensors configured to detect the contact pressure of the contact surface of each of the cells and a monitor operatively coupled with the pressure sensors. The monitor is configured to receive, from at least one of the set of contact pressure sensors, a pressure signal indicative of the contact pressure of one or more of the cells. A controller operatively coupled with the monitor is configured to control internal air pressure of the cells as a function of the contact pressures as specified by the pressure signal. To that end, the controller is configured to automatically reduce the internal air pressure of the given cell and the internal air pressure of the adjacent cell in response to determining that the contact pressure of the given cell exceeds or is equal to a predefined threshold contact pressure. Accordingly, the contact pressure of the given cell is configured to reduce when the internal air pressure of the given cell is reduced.

The controller also may be configured to automatically increase the internal air pressure of the given cell and the internal air pressure of the adjacent cell in response to determining that the contact pressure of the given cell is equal to or less than the predefined threshold contact pressure. Also, the plurality of cells may take on any of a variety of shapes, such as that of a hexagon. Preferably, the cells are part of a mattress, blanket, or wheelchair.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIGS. 1A and 1B schematically shows a user lying in a supine position on a cross-sectional view of a mattress configured in accordance with illustrative embodiments of the invention.

FIG. 2A schematically shows a cross-sectional of the mattress of FIGS. 1A and 1B in accordance with illustrative embodiments.

FIGS. 2B and 2C schematically show cross-sectional views of the mattress of FIG. 2A respectively when inflating and deflating.

FIGS. 3A-3C respectively show plan, perspective partial-cutaway, and cross-sectional schematic views of a two-dimensional array of pressure management cells of various embodiments.

FIG. 4A schematically shows a wheelchair modality configured in accordance with illustrative embodiments.

FIG. 4B schematically shows a prosthetic cushioning modality configured in accordance with illustrative embodiments.

FIG. 4C schematically shows a footwear modality configured in accordance with illustrative embodiments.

FIG. 5 schematically shows the interaction of various active logical portions of the system in accordance with illustrative embodiments.

FIG. 6 shows a process of using the system in accordance with illustrative embodiments.

FIG. 7 shows a process describing various modes that may be used with illustrative embodiments.

### DESCRIPTION OF ILLUSTRATIVE EMBODIMENTS

In illustrative embodiments, a body support system monitors and automatically modifies its support surface to minimize the risk of pressure injuries (e.g., ulcers) to users. To that end, after detecting that the contact pressure of a region of the support surface exceeds some prescribed threshold(s), the system intelligently reduces the contact pressure at that location, reducing the stress to the part of the user's body contacting that portion of the surface. Favorably, this reduction in pressure correspondingly reduces the risk of pressure injuries that may otherwise develop after prolonged exposure to that excessive contact pressure. Details of illustrative embodiments are discussed below.

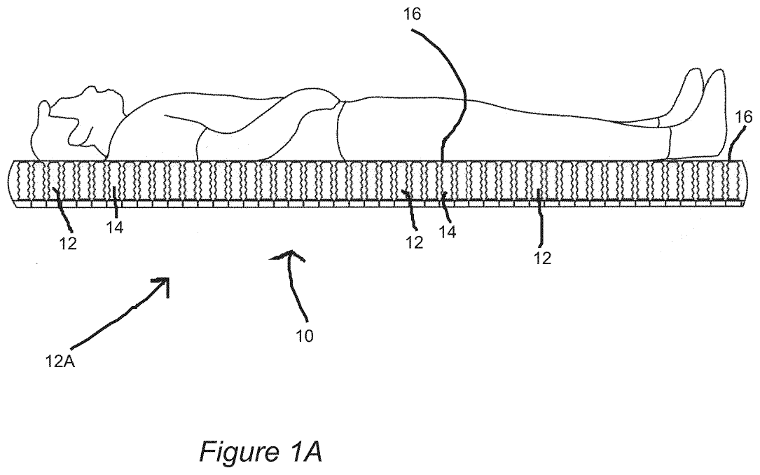

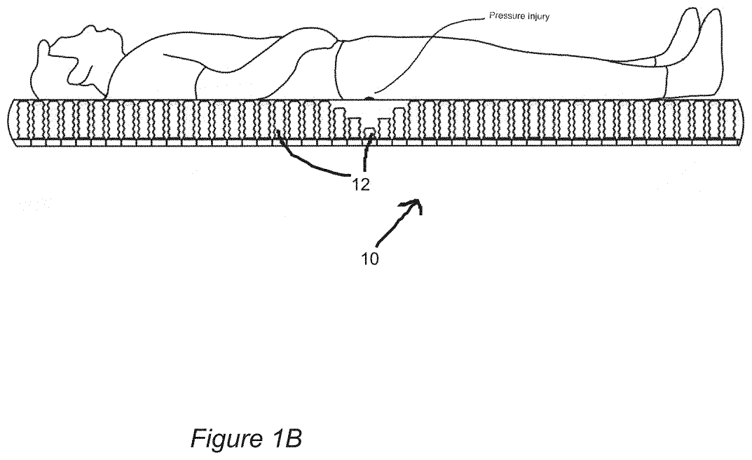

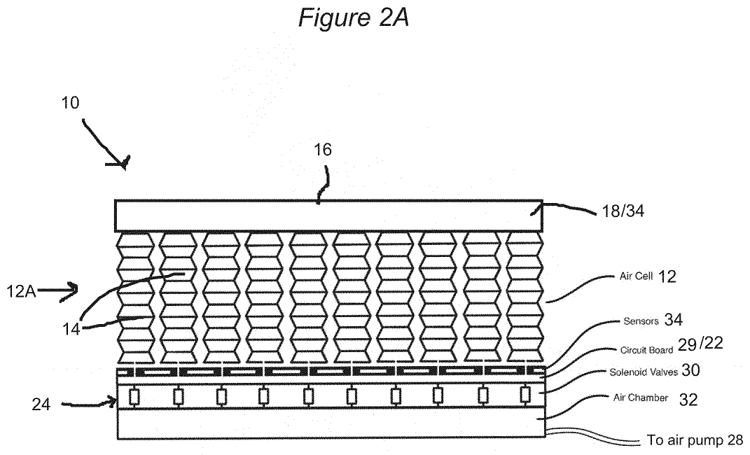

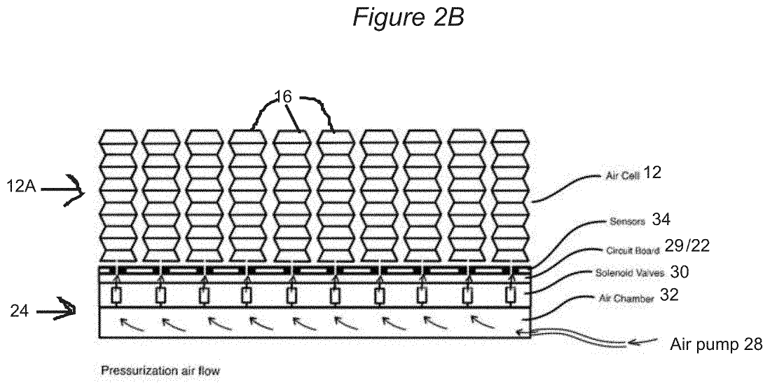

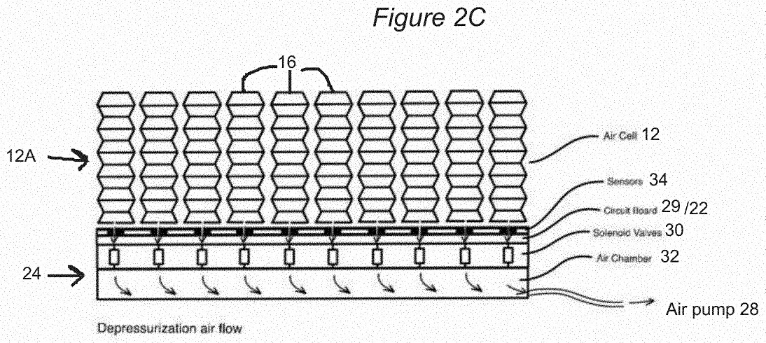

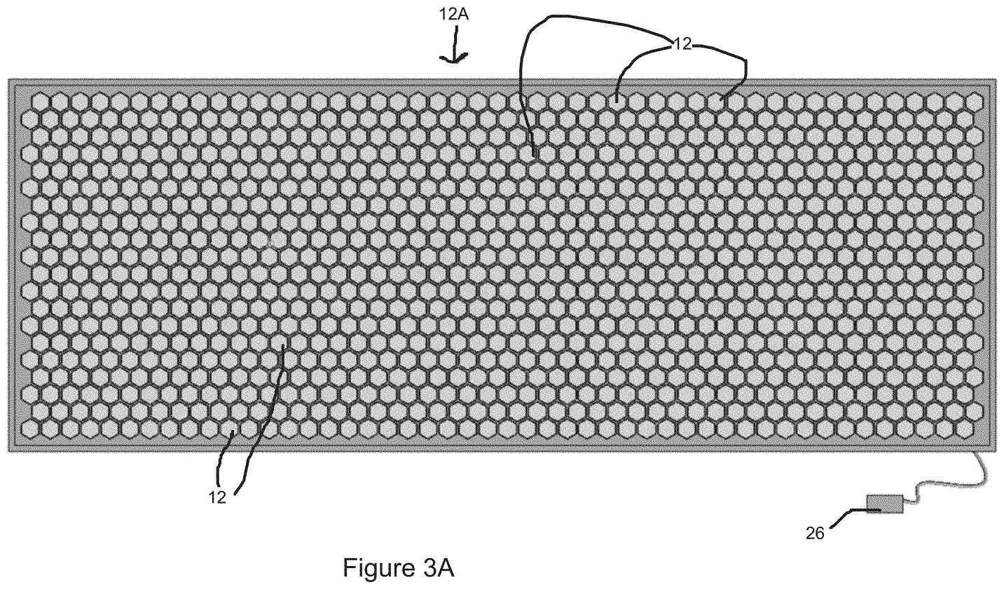

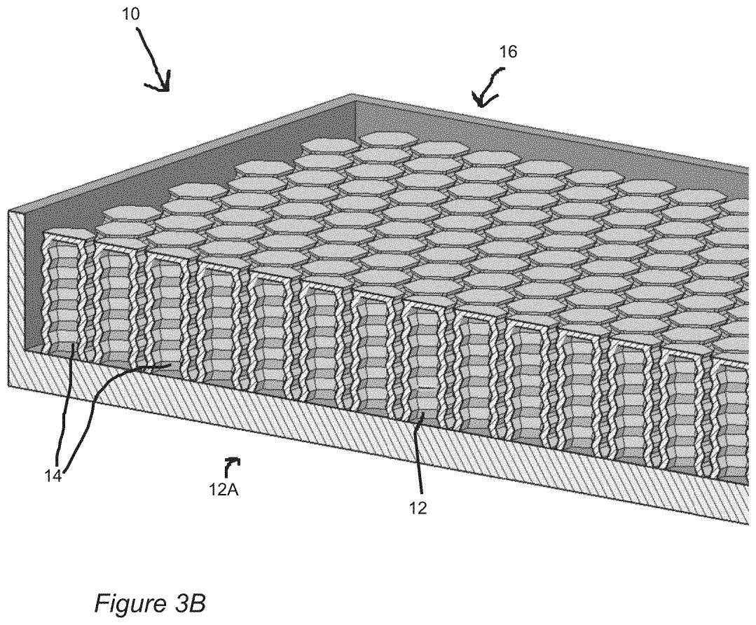

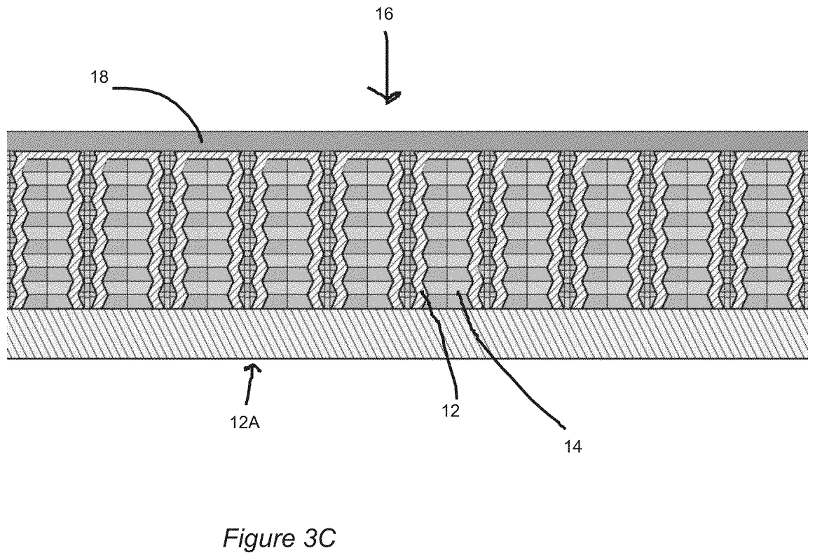

FIGS. 1A and 1B schematically shows a user/person lying in a supine position on a cross-sectional view of a managed surface or platform 10 (in this embodiment, a mattress and also identified by reference number 10) configured in accordance with illustrative embodiments of the invention. As shown, the mattress 10 has a plurality of individualized members or nodes (referred to below also as “cells 12”) that are coordinated to support the user. Each of the plurality of cells 12 preferably has a hollow interior 14 configured to receive an inflation fluid (e.g., air or liquid). The amount of fluid in the interior 14 of a given cell 12 correspondingly at least in part controls the contact pressure that cell 12 applies to the person at its corresponding point of contact. Specifically, each cell 12 that contacts the user has a top contact surface (top from the perspective of the drawing and better shown in FIGS. 2B and 3A) that applies a specific surface or contact pressure to a corresponding bottom contact area of the user. It is this region that illustrative embodiments control.

As discussed in greater detail below, a plurality of adjacent cells 12 can be configured to reduce their individual pressures, producing a net contact pressure reduction at user locations that some of those adjacent cells 12 do not physically contact. FIG. 1B shows one example of this configuration with several cells 12 having differing heights, typically a result of each of those cells 12 having different pressures. As shown, a central cell 12 directly under the user's pressure injury is lowest and likely has the lowest internal pressure, while adjacent cells 12 (i.e., a series of adjacent cells, some of which are not adjacent to the central cell 12) have a greater internal pressure than that of the central cell 12. Some such adjacent cells 12 do not contact the user while others do contact the user . . . although preferably at specific contact pressures and durations that do not produce pressure injuries. This provides a more gradual and even pressure reduction in the region around the pressure injury.

FIG. 2A schematically shows a cross-sectional view of a portion of the mattress 10 of FIGS. 1A and 1B in accordance with illustrative embodiments. This embodiment may be considered to form a layered platform 10 that supports the user, monitors contact pressure (and optionally temperature), and controls fluid flow into and out of the interiors 14 of the individual cells 12. Indeed, those skilled in the art should recognize that this structure can expand beyond a mattress 10 (e.g., to other modalities, discussed below). Accordingly, discussion of a mattress 10 is exemplary and not intended to limit various other embodiments.

To that end, the mattress 10 has a sensing layer 18 that receives the person (or animal) lying on the mattress 10 and senses pressures and, in some embodiments, temperatures. In addition, as shown in greater detail in FIGS. 3A-3C, to manage contact pressures, the mattress 10 has an array of the noted cells 12 that collectively cushion the sensing layer 18. Specifically, the array of cells 12 are controlled to deflate or inflate respectively to decrease or increase the pressure applied to the contact area of the user (the “contact pressure”). Circuitry 22 below the two-dimensional array controls one or more valves 30 (e.g., solenoid valves) that control fluid flow into or out of selected one or more of the individual cells 12. The mattress 10 also has a bottom layer with an air distribution system 24 that selectively supplies air to one or more of the cells 12. These layers together form the cushioning system as a single, preferably integrated support unit.

A controller 26 (discussed in greater detail below) manages the layered platform 10 to control inflation/deflation and otherwise operate the system. For example, the controller 26 may have a panel with a main display and touch panel for manually adjusting settings and turning on and off the cushioning system. The controller 26 also may have a central control system, communications devices (e.g., Bluetooth, WIFI, or a transceiver), and an associated air pump 28 with valves 30 (e.g., solenoid valves). As such, the control panel may be a single device or multiple individual devices that coordinate to provide the desired functionality.

In illustrative embodiments, the sensing layer 18 includes temperature sensing material having an array of temperature sensors in a flexible format, and pressure sensing material having an array of pressure sensors 34 (e.g., MEMS pressure sensors or the layer discussed below). Alternatively, temperature sensors, as well as pressure sensors 34, can be embedded directly into the cells 12 below the sensing layer 18. This enables the temperature or pressure to be detected at each cell 12 or on a more granular level. Both a map of the pressure and temperature then can be displayed on the central control panel, a mobile device application, or exported to an external device. These data can aid in the detection and diagnosis of a pressure injury or other medical complications.

The sensing layer 18 can be formed as one layer, or multiple sub-layers. For example, the temperature sensors can be formed on a first sub-layer while the pressure sensors 34 can be formed on a different sub-layer. When implemented as sub-layers, some embodiments may form the pressure sensor sub-layer to have three layers of material that together form an array of sensors 34 (e.g., piezoelectric sensors). The top and bottom layers of this sub-layer can include conductive strips that are either woven into fabric or placed on top of a flexible piece of material. The sensors of these two layers can be integrated into one or more printed circuit boards (e.g., a flex circuit) or other technology and communicate with the controller 26 using conventional techniques.

Some embodiments implement the sensors below the cells 12. For example, at least one of these two layers can be integrated into a printed circuit board 29 below the cells 12 (e.g., positioning the circuit board beneath a set of cells 12, FIGS. 2A-2C). In either case, between these two layers is a conductive, flexible material, typically made from graphite or carbon-based material. The top and bottom layers of this sub-layer are oriented so that the strips of conductive material run perpendicular to each other forming square shaped contact points at their intersection. Utilizing the differential in resistance caused by applied pressure on this surface, the pressure can be detected and measured at each intersection of the conductive strips. In this example, the granularity of the pressure map is determined by the number of conductive strips, the width of the conductive strips, and the distance between the conductive strips that are on or embedded in the flexible material. Utilizing this embodiment, the pressure can be detected at each cell 12 or on a more granular level.

The array of cells 12 may be formed from a flexible material having the noted hollow interior 14, acting as a central air chamber, which can be either pressurized (FIG. 2B) or depressurized (FIG. 2C) utilizing a system of valves 30 and the air pump 28. Each of the cells 12 may be fluidly isolated from other cells 12 via at least one valve 30. An increase of air pressure inside the cell 12 (i.e., the “internal air pressure” of the cell) causes the applied force of the cell 12 on the contact area with the body to increase (i.e., increasing the contact pressure). In a corresponding manner, a decrease of air pressure in the cell 12 causes the applied force of the cell 12 on the contact area of the body to decrease (i.e., decreasing the contact pressure). Accordingly, controlling the timing of the actuation of each valve 30 and the pressure of the air inside and outside of the cell 12 controls the contact pressure of each cell 12.

Those skilled in the art may form the cells 12 to have any of a variety of useful geometries. For example, in illustrative embodiments, each cell 12 is hexagonal. Those skilled in the art may make them another shape, such as cylindrical, circular, irregularly shaped, elliptically shaped, rectangular, etc. Moreover, among other things, the geometry of the cell 12 can be either bellows-like or dome-like. In addition, the top surface of the cell 12; namely, the part of the cell that contacts the body (e.g., contacting through the sensing layer 18) can be generally flat when fully inflated, have a concavity, have a convex shape (e.g., a dome-like shape), or have a combination of two or more of the three noted options. This surface of each cell 12 is referred to as the “contact surface 16.”

One embodiment includes a single, uniform air chamber 32 below the cells 12 and connects with each cell 12 through their respective solenoid valve(s) 30. Another embodiment has an air chamber 32 for each set of cells 12. For example, the array 12A may include 15 sets of ten cells 12 and thus, have separate air chambers 32 for each set of cells.

When the air chamber 32 has a high pressure, and the solenoid valve 30 on an individual cell 12 is opened, the pressure in the cell 12 increases. As discussed in greater detail below, a real-time reading of the contact pressure across the contact area enables the controller 26 to then automatically close the valve 30 at the time the desired pressure is reached. Correspondingly, when the air chamber 32 has a low pressure and the solenoid valve 30 on an individual cell 12 is opened, then the pressure in the cell 12 decreases. The real-time reading of the pressure across the contact area will then allow the controller 26 to close the valve 30 at the time the desired pressure is reached.

Another embodiment includes two valves 30 controlling each cell 12. In that case, one valve 30 connects with the underlying air chamber 34, while the other valve 30 permits air release into the open air/environment. When the underlying air chamber 34 is pressurized using an air pump 28, individual solenoid valves 30 can be opened to increase the pressure in any individual cell 12. When any individual cell 12 is to be depressurized, the solenoid valve 30 that connects to open air can be opened, allowing for the release of air. The period for which the solenoid valve 30 is opened and then closed is determined based on the real-time readings of pressure across the contact area at each cell 12.

Another embodiment uses one-way valves 30 between each cell 12 coupled with a solenoid valve 30 beneath each cell 12. Utilizing a configuration of rows or columns, each can have an air tube attached to the first cell 12 on each row or column. One-way valves 30 positioned between each cell 12 enable air to flow into the cells 12, but not out of the cells 12. The air pump 28 is then turned on to pressurize all of the cells 12 in that row or column. To depressurize each cell 12 to the desired pressure on the contact area, the solenoid valve 30 is then opened on the bottom of the cell 12 allowing for the flow of air out of the individual cell 12.

Illustrative embodiments have a plurality of prescribed operation modes (discussed below) configured to selectively depressurize or pressurize each cell 12. Utilizing pneumatic controls as discussed above and below, the pressure of each cell 12 can be changed to the pressure specified by the controller 26. Each cell 12 therefore can have a different pressure applied to the contact area. This capability enables a plurality of configurations of intelligently apply a pressure distribution that can be achieved using this cushioning system.

FIGS. 3A-3C respectively show plan, perspective partial-cutaway, and cross-sectional schematic views of the two-dimensional array 12A of pressure management cells 12 of various embodiments. In a manner similar to FIGS. 2B and 2C, which omit the sensing layer, these figures have omitted some of the overall unit (e.g., the sensing layer) to show more detail of the cell array 12A, as well as the interiors 14 of the cells 12. Among other things, these views show the platform in another way, including its contact surface 16.

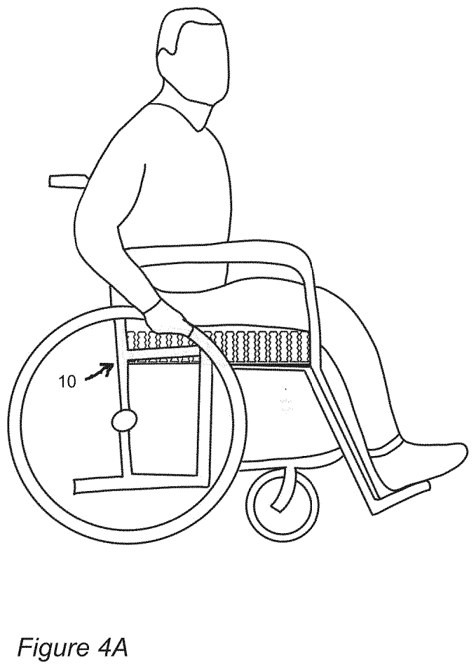

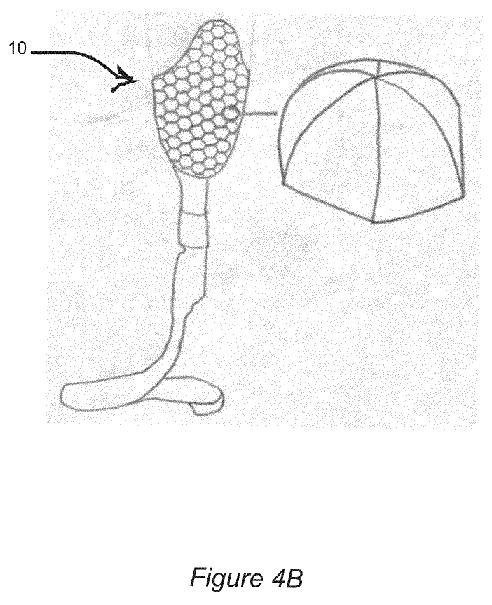

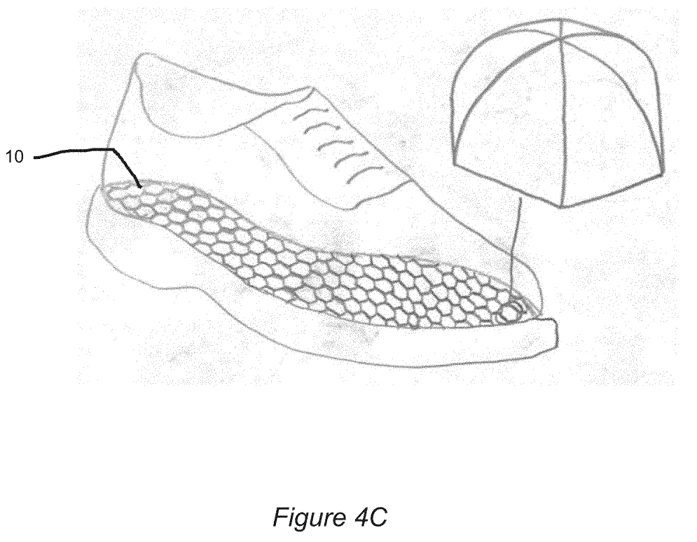

FIGS. 4A-4C schematically show examples of three additional modalities that may use the body support system. To that end, FIG. 4A schematically shows a wheelchair modality 10A configured in accordance with illustrative embodiments, FIG. 4B schematically shows a prosthetic cushioning modality 10B configured in accordance with illustrative embodiments, and FIG. 4C schematically shows a footwear modality 10C configured in accordance with illustrative embodiments. FIG. 4C also shows a close up view of an exemplary cell 12 having a convex top contact surface 16. Indeed, as noted above, those skilled in the art may use this body support system/platform 10 with other modalities, such as a blanket modality.

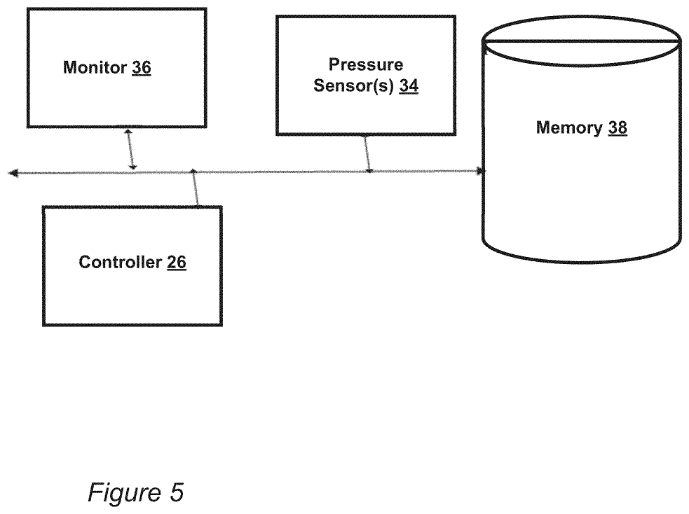

As noted, a plurality of components cooperate to provide the desired functionality, and FIG. 5 schematically shows some of those components. Each component is operatively connected by a conventional interconnect mechanism. FIG. 5 simply shows a bus communicating each the components. Those skilled in the art should understand that this generalized representation can be modified to include other conventional direct or indirect connections. Accordingly, discussion of a bus is not intended to limit various embodiments.

Indeed, it should be noted that FIG. 5 only schematically shows each of these components. Those skilled in the art should understand that each of these components can be implemented in a variety of conventional manners, such as by using hardware, software, or a combination of hardware and software, across one or more other functional components. For example, the controller 26 may be implemented using a plurality of microprocessors executing firmware. As another example, the controller 26 may be implemented using one or more application specific integrated circuits (i.e., “ASICs”) and related software, or a combination of ASICs, discrete electronic components (e.g., transistors), and microprocessors. Accordingly, the representation of the controller 26 and other components in a single box of FIG. 5 is for simplicity purposes only. In fact, in some embodiments, the controller 26 of FIG. 5 is distributed across a plurality of different machines—not necessarily within the same housing, chassis, or even the same building.

It should be reiterated that the representation of FIG. 5 thus is a significantly simplified representation. Those skilled in the art should understand that such a system typically has other physical and functional components. Accordingly, this discussion is in no way intended to suggest that FIG. 5 represents all of the elements of this system of cooperating components.

This system shown in FIG. 5 interacts with the noted array 12A of expandable, compressible cells 12. For example, the system may control a given cell 12 with a given contact surface 16, and at least one cell 12 adjacent to the given cell 12 (“adjacent cell 12”). To that end, the system includes, among other things, memory 38 for storing data (e.g., parameters of the process) and control applications, and the above noted pressure sensor 34, which detects the contact pressure at the contact surface 16 of some or all of the cells 12 in the array 12A. This pressure sensor 34 can be implemented as a plurality of pressure sensors 34, or a single pressure sensor 34 capable of detecting pressures at multiple locations. The system also has a monitor 36 configured to receive, from at least one the pressure sensor 34, a pressure signal indicative of the contact pressure of one or more of the cells 12. The noted controller 26, which is operatively coupled with the monitor 36, is configured to control internal air pressure of the cells 12 as a function of the contact pressures as specified by the pressure signal.

In preferred embodiments, the controller 26 is configured to automatically (i.e., without direct human intervention) reduce the internal air pressure of the at least one cell 12 (e.g., in a given cell 12) and the internal air pressure of one or more adjacent cell(s) 12 when it determines that the contact pressure of the given cell 12 exceeds or is equal to a predefined threshold contact pressure. As noted, adjacent cells 12 can include three or more cells 12. While some adjacent cells 12 may have a cell 12 between it and another of the adjacent cells, it still is considered “adjacent” when it forms a contiguous line of cells 12 managed by the controller 26 in response to a pressure event. In other words, three or more cells 12 may form a set of adjacent cells 12 that the controller 26 manages in response to a single pressure event. Each of the cells 12 that is part of the three or more cells 12 is adjacent to at least one of the other three or more cells 12. Those cells 12 do not necessarily form a line and may form a different pattern (e.g., a generally circular or triangular pattern).

Accordingly, in certain circumstances, this reduces the contact pressure of the given cell 12, as well as that of one or more adjacent cells 12, when the internal air pressure of the given cell 12 is directed to be reduced. This favorably reduces the risk of pressure injuries from developing without requiring manual intervention.

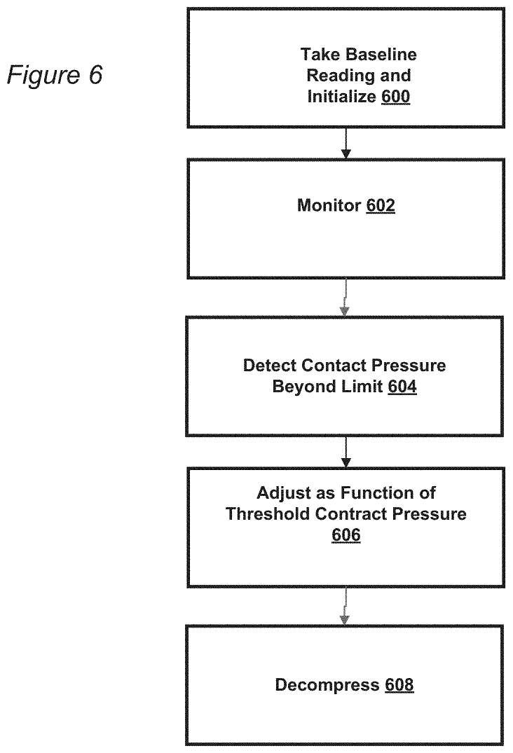

FIG. 6 shows a process of managing pressure injuries with the systems of FIGS. 1-5 in accordance with illustrative embodiments. It should be noted that this process is substantially simplified from a longer process that normally would be used to manage pressure injuries. Accordingly, the process may have additional steps that those skilled in the art likely would use. In addition, some of the steps may be performed in a different order than that shown, or at the same time. Those skilled in the art therefore can modify the process as appropriate. Moreover, as noted above and below, many of the noted specifics, such as numbers discussed, are but one of a wide variety of different materials and structures that may be used. Those skilled in the art can select the appropriate specifics depending upon the application and other constraints. Accordingly, discussion of such specifics is not intended to limit all embodiments.

The process of FIG. 6 begins at step 600, in which an operational mode or setting is selected and the system takes a baseline reading of the user when they initially rest on the array platform 10. Specifically, this baseline, initialization process preferably begins when the system is first turned on. Just before turn-on, all cells 12 are essentially substantially completely depressurized. Then, after turn-on, all cells 12 are pressurized (e.g., to an equal pressure). After contacting the controlled contact surface 16 of the platform 10, the controller 26 may guide the user to move into different positions to produce a baseline pressure map and temperature map of multiple positions. When used in a mattress modality 10 (e.g., FIG. 1), for example, the controller 26 first may prompt the user to lay in a supine position, and then a lateral position. For the wheelchair modality 10A (e.g., FIG. 4A), the user first may be prompted to place the chair in their normal position, and then in a tilted back position. These readings preferably are re-taken if any dramatic change in weight or anatomy is detected through the normal, post-initialization readings of the pressure and temperature sensing systems.

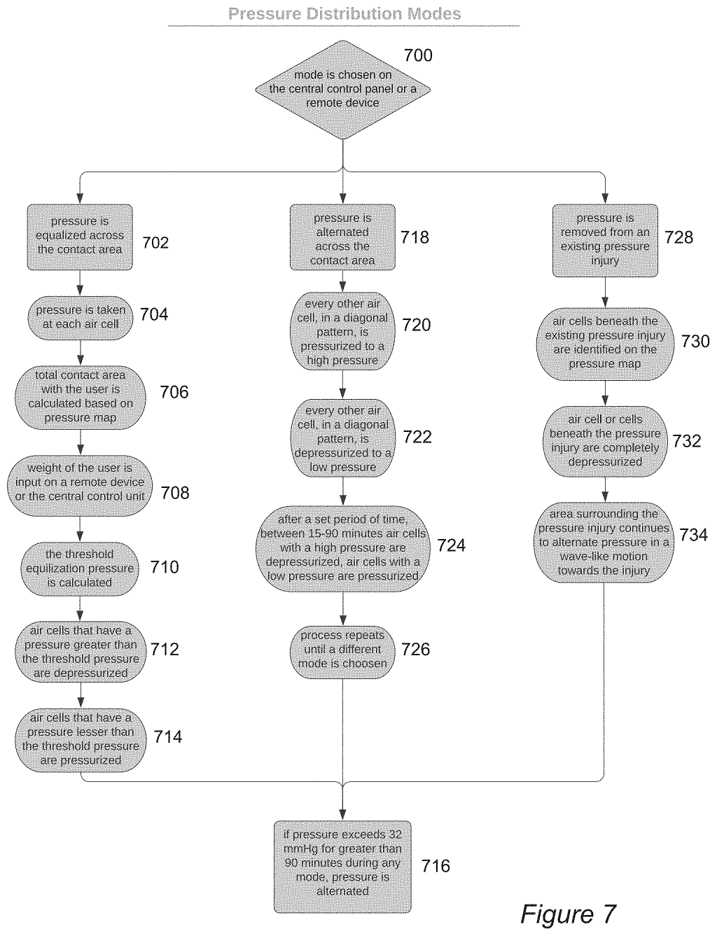

The system also may operate in any of a plurality of the notes operational modes, which the user may select or the system may be configured to select. Various of the modes act to distribute the pressure across the contact area in various combinations. One basic mode simply pressurizes the cells 12 a prescribed amount and monitors as discussed below. Details of some of these modes are discussed in greater detail below with regard to FIG. 7.

After system initialization, the user may sit or lay in any position, and the system will begin operating in the selected mode. For example, using the pressure sensors 34, the system may produce another dynamically changing pressure map of the user's body on the contact surface 16. This pressure map, which likely will vary, is used to determine the inflation pressure of the various cells 12.

In accordance with illustrative embodiments, the pressure of the cells 12 changes as a function of contact pressure of the cells 12 and the mode selected by the user, caretaker, or medical professional. To that end, the process continues to step 602 in which the monitor 36 tracks the contact pressure of each of the cells 12. Specifically, the pressure sensors 34 of each cell 12 conveys a pressure signal to the monitor 36, and that pressure signal may be forwarded to the controller 26 to determine if there are any prescribed aberrations, such as high contact pressures over some unit of time. Alternatively, the monitor 36 may simply notify the controller 26 of these aberrations and not forward all of the pressure signals. In a distributed configuration, such an alternative embodiment may reduce data congestion on the communication network.

The controller 26 automatically takes action after detecting a prescribed and/or range of contact pressures on the contact surface 16 of one or more of the cells 12 (step 604 and 606). As noted, this prescribed pressure may have a temporal component too. For example, when the detected pressure equals or exceeds the threshold for a specified time (e.g., 30-60 seconds, or one to five minutes), then it may take some action. Rather than being automatic, however, the noted action may be completed after requesting such action from some logic or person (e.g., a caregiver or the user).

Generally, as noted above for a given cell, in response to detecting that the contact pressure meets some criteria (e.g., it equals or exceeds a prescribed threshold), the controller 26 modifies the internal pressure of the given cell 12 (i.e., in its interior 14) to reduce the contact pressure at that cell 12. To further optimize the process, the controller 26 reduces the internal pressure at one or more cells 12 adjacent to the given cell 12. Preferably, this at least produces a contact pressure reduction at the given cell 12 that is more than the reduction of the contact pressure at the adjacent cell(s) 12. In some embodiments, both pressure reductions produce a non-zero contact pressure and internal pressure. Alternatively, one or both may have pressure reductions to effectively decompress the cell 12 for a minimal or zero contact/internal pressure.

Accordingly, the controller 26 manages the contact pressure of the cells 12 as a function of the criteria, which, in this example, is a threshold contact pressure. In some embodiments, this reduction in contact pressure causes the height reduction of the given cell 12 to be greater than the height reduction of one or more of the adjacent cell(s) 12 (e.g., see FIG. 1B).

The appropriate pressure threshold and times may be selected based on testing and/or literature studies. In some embodiments, the threshold may be constant across the entire surface. In other embodiments, however, the threshold may vary based on the location of the given cell 12. For example, the system may be configured to detect generally the parts of the body on its top surface and recognize that some parts may be able to withstand different levels of contact pressure. Those skilled in the art thus can select appropriate threshold levels for the various parts of the system.

The process concludes at step 608 when the user no longer contacts the contact surface 16. To save energy, the controller 26 may automatically depressurize the cells 12 and re-start upon detection of the user again contacting the contact surfaces 16 of the cells 12.

FIG. 7 shows a process for selecting one of three modes of operation in accordance with illustrative embodiments. As with the process discussed above with regard to FIG. 6, this is substantially simplified from a longer process that normally would be used to manage pressure injuries. Accordingly, the process may have additional steps that those skilled in the art likely would use. In addition, some of the steps may be performed in a different order than that shown, or at the same time. Those skilled in the art therefore can modify the process as appropriate. Moreover, as noted above and below, many of the noted specifics, such as numbers discussed, are but one of a wide variety of different materials and structures that may be used. Those skilled in the art can select the appropriate specifics depending upon the application and other constraints. Accordingly, discussion of such specifics is not intended to limit all embodiments.

The process begins at step 700, in which the mode is chosen on a central control panel or a remote device. This process shows three exemplary modes—an “equalizing” mode on the left side of the figure (steps 702-714), a “removal” mode on the right side of the figure (steps 728-734), and an “alternating” mode in the center of the figure (steps 718-726). Each mode is discussed below.

When in the equalizing mode, the controller 26 equalizes pressure across the contact area (step 702), and the user sits, lays, or applies pressure to the system. At that point, the monitor 36 measures the contact pressure across the contact area measured (step 704), creating the noted pressure map. The controller 26 then records pressure on each cell 12 across the contact area using the pressure map (step 706). Using the contact pressure and total contact area, the controller 26 calculates the user's weight (or it may be input into the system, e.g., via a mobile device application or control panel), step 708.

At that point, the controller 26 calculates an appropriate threshold contact pressure and the pressure that should be applied by each cell 12 to equalize pressure applied across the contact area (step 710). The controller 26 then may initiate an equalizing algorithm to equalize the cells 12 across the array 12A. Cells 12 that are currently applying a contact pressure higher than the desired pressure with the contact area are automatically or manually depressurized (step 712). Cells 12 that are currently applying a pressure lower than the desired contact pressure with the contact area are then automatically or manually pressurized (step 714). All internal cell-pressure valves 30 are then closed after the desired pressure at each cell 12 is reached.

The pressurization and depressurization in this mode will repeat when there is a dramatic decrease in the amount of air in the cells 12 after an extended period (e.g., from 15-90 minutes). The process will also repeat if the contact pressure applied by any cell 12 (on the contact area of a given cell) exceeds a prescribed amount over a prescribed time period (e.g., 32 mmHg for more than 1 or 2 hours, step 716). Importantly, as with the process of FIG. 6, the controller 26 monitors for contact pressures, relative to the threshold contact pressure, and adjusts the internal air pressure (and consequently the contact pressure) of one or more cells 12 and, in some embodiments, their adjacent cells 12.

Additionally, the process will repeat if there is any prescribed shift in the position of the user. This could include a shift from supine to lateral if laying, or tiling back if in a wheelchair 10A. As noted, step 716 also may more generally use the process described in FIG. 6 to control the internal pressure of a set of adjacent cells 12.

A second mode, the alternating mode at the center of FIG. 7, alternates contact pressure across the array 12A in a geometric pattern, such as in a diagonal pattern. Specifically, the controller 26 alternates contact pressure across the contact area (step 718), and causes every other cell, in a diagonal pattern, to pressurize to the high pressure (step 720). In a corresponding manner, the controller 26 causes the other cells 12, in the diagonal pattern, to depressurize to a low pressure (step 722). These high and low pressures may be pre-selected and/or based on baseline information about the user. In specified time intervals, half of the cells 12 thus will be pressurized and the other half of the cells 12 will be depressurized or have a significantly reduced interior pressure (step 724). For example, in five minute increments, the relevant steps will repeat so that the half of the cells 12 that were at high pressure are depressurized to low pressure, and the half of the cells 12 that were at low pressure are pressurized to high pressure. The process will repeat if the pressure caused by any cell 12 on the contact area exceeds a prescribed contact pressure for a prescribed time period (e.g., 32 mmHg for more than 2 hours), automatically alternating pressure using the process described (step 716).

The third operational mode, the removal mode at the right side of FIG. 7, permits the fluctuation of the cells 12 surrounding the pressure injury in a wavelike motion to promote blood flow toward the injury site. At the same time, it removes substantial contact pressure (e.g., completely removes contact) to a contact surface 16 with a pressure injury. Specifically, at step 728, the controller 26 locates the cell 12 contacting a pressure injury and reduces or removes that cell 12 from significant contact or pressure against the injury. The relevant cell(s) 12 then are identified and marked on the pressure map (step 730) and, as noted, may be completely depressurized (step 732). Accordingly, the area surrounding the pressure injury may continue to receive the alternating pressure toward the injury (step 734).

For example, the controller 26 may cause the array 12A to produce a pulsating-like motion, such as in a circulating wave-like formation, to pulsate inwardly toward the pressure injury, gently massaging the surrounding area. To that end, cells 12 in the area around the injury, in a circular formation, first will substantially completely depressurize. A ring-like formation of cells 12 farthest from the injury site will then pressurize. The pressurized ring of cells 12 then depressurize and a ring-like formation of cells 12 closer to the site pressurizes. This process continues creating a wave-like motion, which enhances blood flow toward the pressure injury. Pressure on the injury site itself remains substantially minimal (e.g., at zero pressure) until a different operational mode is selected.

Throughout each of these modes, the continuous monitoring of pressure and temperature permits the system to detect the development of a pressure injury. A pressure injury can also first be identified by the user or a caretaker. Dramatic changes in the pressure map indicating either an increase or decrease in pressure compared to the original, baseline pressure map over an extended period may indicate a problem—a pressure injury. Notable changes in temperature can also be detected; for example an increase in temperature of greater than 2 degrees Celsius for an extended period at a specific region of the body can signal a problem. If a significant change in pressure, temperature, or both is detected for an extended period, the central control panel and/or the mobile application display a warning, or some other indicia may indicate a problem (e.g. an audible warning). Warnings preferably include the location, magnitude, and duration of the change in pressure, temperature or both. A medical professional, caretaker or the user can then examine this area to identify if further care needs to be taken.

When the area is identified as a pressure injury beginning to form (e.g., an ulcer), or if a caretaker has identified a pressure injury independent of the system, contact pressure can be removed from the specified area. If the system has identified significant changes in pressure and temperature, the medical professional, caretaker, or user have the option to completely remove pressure from the site. When the medical professional, caretaker or user identifies the problematic area, the identified site can be selected utilizing the central control panel or mobile application. After the injury has been identified by the device or caretaker and verified by a medical professional, then a “remove pressure” button on the control panel can be selected, causing the system to remove contact pressure from the indicated area (e.g., FIG. 1B). The cells 12 underlying the specified part of the contact area will be partially or completely depressurized until the pressure reading is low or equal to zero. The area surrounding the pressure injury will then continue to operate, such as by alternate pressure, if the mode selected has such functionality.

As noted, each of these modes may be selected and controlled through the central control panel, which may be implemented, in some embodiments, as a box-like device. This control panel may be part of the controller 26 of FIG. 5. Among other ways, the control panel may couple with the cushioning system through air tubes, a control line, and/or a power supply line. The exterior may have a display and touch control panel that enables selection of a multitude of modes that have been described above. To improve functionality, this display can visually show pressure and temperature maps with color codes indicating pressures and temperatures of varying levels (e.g., red for high pressure).

As noted above, the controller 26 and control panel thus may have a number of different components to optimize functionality for a given application. Among other things, these components may include the above noted printed circuit board 29, solenoid valves 30, air tubing, the air pump 28, WIFI, wired Internet connection, and Bluetooth and other communication devices/transceivers. The printed circuit board 29 has circuitry 22 that, among other things, controls actuation of the solenoid valves 30, processing of the pressure and temperature mapping, the input and output controls of the modes selections, and the relay of information, through Bluetooth or the transceiver, to external devices. As noted, solenoid valves 30 or other valves 30 selectively permit air to be pumped into or out of the cushioning system with the air pump 28. Bluetooth and/or transceivers relay mode selection to the cushioning system or the pressure and temperature maps to and from the system.

Accordingly, illustrative embodiments intelligently monitor a user and their contact surface 16 to mitigate the risk of a pressure injury. This system can monitor for these potential complications in an automatic fashion, requiring minimal intervention by a caretaker or user.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A pressure injury management apparatus comprising:
a two-dimensional array of expandable, compressible cells, each cell having a contact surface with an associated contact pressure, the array of cells including a given cell with a given contact surface, the array of cells also having at least one cell adjacent to the given cell (“adjacent cell”);
a set of contact pressure sensors configured to detect the contact pressure of the contact surface of each of the cells;
a monitor operatively coupled with the pressure sensors, the monitor configured to receive, from at least one of the set of contact pressure sensors, a pressure signal indicative of the contact pressure of one or more of the cells;
a controller operatively coupled with the monitor, the controller configured to control internal air pressure of the cells as a function of the contact pressures as specified by the pressure signal,
the controller configured to automatically reduce the internal air pressure of the given cell and the internal air pressure of the adjacent cell in response to determining that the contact pressure of the given cell exceeds or is equal to a predefined threshold contact pressure,
the contact pressure of the given cell configured to reduce when the internal air pressure of the given cell is reduced.

2. The apparatus as defined by claim 1 wherein the controller is configured to automatically increase the internal air pressure of the given cell and the internal air pressure of the adjacent cell in response to determining that the contact pressure of the given cell is equal to or less than the predefined threshold contact pressure.

3. The apparatus as defined by claim 1 wherein the plurality of cells are shaped in a hexagonal shape.

4. The apparatus as defined by claim 1 wherein the array of cells are part of a mattress, blanket, or wheelchair.

5. The apparatus as defined by claim 1 wherein the adjacent cell has an adjacent cell contact surface, the pressure reduction response causing the controller to reduce the contact pressure of the adjacent cell contact surface to a non-zero contact pressure.

6. The apparatus as defined by claim 1 wherein each of the cells is fluidly isolated from other of the cells via at least one valve.

7. The apparatus as defined by claim 1 wherein the controller is configured to automatically reduce the internal air pressure of the given cell to a non-zero pressure in response to determining that the contact pressure of the given cell exceeds or is equal to a predefined threshold contact pressure.

8. The apparatus as defined by claim 1 wherein after reducing the internal air pressures of the given and adjacent cells, the given cell has a first air pressure and the adjacent cell has a second air pressure, the first air pressure being less than the second air pressure.

9. The apparatus as defined by claim 1 wherein after reducing the internal air pressures of the given and adjacent cells, the given cell has a first height and the adjacent cell has a second height, the first height being less than the second height.

10. The apparatus as defined by claim 1 wherein the controller is configured to automatically increase the internal air pressure of the given cell when the given cell does not exceed the predefined threshold contact pressure.

11. The apparatus as defined by claim 1 wherein the controller is configured to produce a changing, periodic inflation pattern for the array of cells.

12. A process of managing pressure injuries, the method comprising:
providing an array of expandable, compressible cells, each cell having a contact surface with an associated contact pressure, the array of cells including a given cell with a given contact surface, the array of cells also having at least one cell adjacent to the given cell (“adjacent cell”);
providing a controller comprising hardware, software, or both hardware and software;
expanding the array of cells with a fluid, each cell having a resultant internal air pressure;
receiving a body on the expanded array of cells, the body contacting the contact surface(s) of a set of the cells;
monitoring the contact pressure of the body on the contact surface of each of the set of cells;
detecting, on the given contact surface of the given cell, a given contact pressure exceeding or equal to a predetermined threshold contact pressure;
producing, by the controller, a pressure reduction response when detecting that the given contact pressure exceeds or equals the predetermined threshold contact pressure,
the pressure reduction response automatically causing the controller to modify the internal air pressure of the given cell and the internal air pressure of the adjacent cell in response to detecting the given contact pressure as a function of the threshold contact pressure,
the pressure reduction response causing the controller to reduce the contact pressure of the given contact surface of the given cell.

13. The method as defined by claim 12 wherein the pressure reduction response causes the controller to reduce the contact pressure of the given contact surface of the given cell to a non-zero contact pressure.

14. The method as defined by claim 12 wherein the adjacent cell has an adjacent cell contact surface, the pressure reduction response causing the controller to reduce the contact pressure of the adjacent cell contact surface to a non-zero contact pressure.

15. The method as defined by claim 12 wherein each of the cells is fluidly isolated from other of the cells via at least one valve.

16. The method as defined by claim 12 wherein each cell has an associated pressure sensor to detect the associated contact pressure on its contact surface.

17. The method as defined by claim 12 wherein after modifying the internal air pressures of the given and adjacent cells, the given cell has a first air pressure and the adjacent cell has a second air pressure, the first air pressure being less than the second air pressure.

18. The method as defined by claim 12 wherein after modifying the internal air pressures of the given and adjacent cells, the given cell has a first height and the adjacent cell has a second height, the first height being less than the second height.

19. The method as defined by claim 12 wherein the pressure reduction response automatically causes the controller to modify the internal air pressure of the given cell and the internal air pressure of the adjacent cell between 1 second and 5 minutes after detecting that the contact pressure equals or exceeds the threshold pressure.

20. The method as defined by claim 12 wherein monitoring the contact pressure of the body on the contact surface of each cell comprises substantially continuously monitoring the contact pressure of the body on the contact surface of each cell.

21. The method as defined by claim 12 wherein monitoring the contact pressure of the body on the contact surface of each cell comprises periodically monitoring the contact pressure of the body on the contact surface of each cell.
